(19) United States
(12) Patent Application Publication
(10) Pub. No.: US 2007/0132119 A1
(43) Pub. Date: Jun. 14, 2007

(54) Use of a super-cooled fluid in the manufacture of contact lenses

(75) Inventors: Sanjay Rastogi, Rochester, NY (US); Gary Friends, Ontario, NY (US); Mahendra Nandu, Pittsford, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/598,356

(22) Filed: Nov. 13, 2006

Related U.S. Application Data
(60) Provisional application No. 60/748,543, filed on Dec. 8, 2005.

(51) Int. Cl. B29D 11/00

(52) U.S. Cl. 264/1.1; 264/334

(57) ABSTRACT

The present invention includes without limitation a process for separating a hydrogel contact lens from at least one mold half selected from the group comprising the anterior half and the posterior half of a contact lens. The process comprising the step of contacting either the contact lens or the one half with a maximum of about 1000 μl of a super-cooled fluid to create a temperature differential between the contact lens and the one half.

### CROSS REFERENCE

This application claims the benefit of Provisional Patent Application No. 60/748,543 filed on Dec. 8, 2005 and is incorporated herein by reference.

### BACKGROUND OF THE INVENTION

1. Field of the Invention

The present invention relates to the release of contact lenses from contact lens molds using a super-cooled fluid.

2. Discussion of Related Art

Most contact lenses are molded in disposable polyethylene or polypropylene molds. Specifically, a contact lens is made of two mold halves. The anterior mold half defines the convex surface of the contact lens. The posterior mold half defines the concave surface of the contact lens. During the molding process, a predetermined amount of a pre-polymer mixture is placed in the anterior mold half. Optionally, a reservoir in the mold is formed to receive excess monomer when the mold halves are placed together.

The posterior mold half is pressed against the anterior mold half forming the desired shape of the contact lens. After the mold halves are placed together, a curing step occurs. In one embodiment, the curing step occurs by application of ultraviolet light that catalyzes a polymerization reaction. After curing, the contact lens is separated from the mold halves by one or more techniques known in the art.

The casting of polymers in molds and the release of the cast materials from the molds is well established. It is also well established that increasing the modulus of the cast material facilitates the removal of the cast material from the mold. For example, it is known that cooling of the mold and/or the cast material not only increases the modulus of the material but also causes the cast material to shrink and separate from the mold, thereby facilitating removal of the cast material from the mold. See U.S. Pat. No. 5,259,998, incorporated by reference herein.

Cryogenic nitrogen, for example, has been used to cause lenses to shrink and separate from a mold. Similarly, it is known that materials cast in the presence of a solvent can be removed from molds by evaporating at least a portion of the solvent thereby causing the modulus of the cast material to increase and the material to shrink and separate from the mold. See Japan Publication No. 01152015, incorporated by reference herein.

European Patent 1,224,073 teaches a process that mechanically decaps the contact lens. Thereafter, a cryogenic fluid is used to release a contact lens from one mold half after decapping. European Patent teaches dispensing a portion of the liquid on the mold or surface of the contact lens. However, super-cooled fluids are difficult to handle due to their volatile nature at room temperature.

It is particularly difficult to dispense a measured amount of super-cooled fluid in an efficient manner that would accomplish the purposes but not waste unnecessary material. The prior art is completely silent about how to accomplish the efficient dosing of small amounts of super-cooled fluid on a contact lens. The present invention satisfies this and other needs.

### SUMMARY OF THE INVENTION

The present invention is a process for separating a hydrogel contact lens from at least one mold half selected from the group comprising the anterior half and the posterior half of an ophthalmic lens. The process comprises the step of contacting either the ophthalmic lens or the one mold half with a maximum of about 1000 μl of a super-cooled fluid. The contacting creates a temperature differential between the contact lens and the one mold half.

In one embodiment, a maximum of about 750 μl, about 600 μl, about 500 μl, 450 μl, about 300 μl and about 250 μl of super-cooled fluid is contacted with either the one half or the ophthalmic lens.

In an embodiment, the hydrogel contact lens is formed of a silicone-containing pre-polymer—typically a hydrophilic pre-polymer.

In another embodiment, the period of time of contacting is a minimum of about 0.1, about 0.5 seconds, about 1 second, about 2 seconds, about 4 seconds or about 6 seconds and/or a maximum of about 20 seconds, about 15 seconds, about 10 seconds, about 8 seconds, about 6 seconds or about 4 seconds.

In another embodiment the contacting occurs by spraying the super-cooled fluid.

In still another embodiment, the super-cooled fluid is at a temperature below about minus 40° C.

In yet another embodiment, the super-cooled fluid is selected from the group consisting essentially of nitrogen, argon, helium, air and carbon dioxide.

### DETAILED DESCRIPTION OF THE INVENTION

One method in practice for making ophthalmic lenses including ophthalmic lenses and intraocular lenses is cast molding. Cast molding of ophthalmic lenses involves depositing a curable mixture of polymerizable lens materials, such as pre-polymers, in a mold cavity formed by two assembled mold sections, curing the mixture, disassembling the mold sections and removing the molded lens. As used herein, the term “pre-polymer” and like terms denote compounds that are inserted into an ophthalmic lens mold to be polymerized by free radical polymerization, the term includes monomers and macromonomers and related terms.

Other post-molding processing steps may also be employed. Representative cast molding methods are disclosed in U.S. Pat. No. 5,271,875 (Appleton et al.); U.S. Pat. No. 4,197,266 (Clark et al.); U.S. Pat. No. 4,208,364 (Shepherd); U.S. Pat. No. 4,865,779 (Ihn et al.); U.S. Pat. No. 4,955,580 (Seden et al.); U.S. Pat. No. 5,466,147 (Appleton et al.); and U.S. Pat. No. 5,143,660 (Hamilton et al.).

Cast molding occurs between a pair of mold sections. Typically, one mold section, referred to as the anterior mold section forms the anterior, convex, optical surface of the ophthalmic lens. The other mold section, referred to as the posterior mold section, forms the posterior, concave, optical surface of the ophthalmic lens. The anterior and posterior mold sections are generally complimentary in configuration.

Typically, a predetermined amount of a liquid mixture including uncured pre-polymer and solvent is placed in the anterior mold section. The posterior mold section is placed over the anterior mold section and takes the shape of the ophthalmic lens. If the desired lens is aspheric, the posterior mold section must be axially positioned relative to anterior mold halve to create proper aspheric shape. The predetermined amount is slightly greater than the volume of the ophthalmic lens mold. A small portion of the pre-polymer mixture overflows in a radially spaced apart overflow reservoir that surrounds the circumference of the ophthalmic lens. Then, the ophthalmic lens is cured by a curing technique such as exposure to ultraviolet radiation.

Once the ophthalmic lens is formed, the mold sections are separated and the molded lens is removed in a multi-step process. The anterior and posterior mold sections are usually used only once for casting an ophthalmic lens prior to being discarded due to the significant degradation of the optical surfaces of the mold sections that often occurs during a single casting operation.

Since, the mold for use in making the ophthalmic lens is generally a single use item, the use of inexpensive materials for the anterior and posterior mold halves is advantageous. Accordingly, a thermoplastic resin or a thermosetting resin such as, for example, polypropylene, polyethylene, polyethylene terephthalate, polystyrene, polycarbonate, polyvinyl chloride, polyamide, polyacetal or fluorocarbon resin is acceptable for use. Examples of amorphous materials include but are not limited to polyethylene terephthalate, polystyrene, polycarbonate or copolymers of ethylene and a cyclic olefin. See WO9947344.

Mold/Mold Half Formation

Formation of the mold sections used in casting occurs through a separate molding process prior to cast molding. In this regard, the mold sections are first formed by injection molding a resin in the cavity of an injection molding apparatus. Molds are formed of an anterior mold half and a posterior mold half. The anterior mold half forms the concave surface of the ophthalmic lens. The posterior mold half forms the convex surface of the ophthalmic lens. As used herein, one mold half refers arbitrarily to either the anterior mold half or the posterior mold half. The other mold half refers to its corresponding pair. Thus, when one mold half refers to an anterior mold half, the other mold half refers to the posterior mold half. Likewise the phrase, “first mold half” and “second mold half” can be used interchangeably with one mold half and the other mold half and no reference is intended to sequence, priority or any criteria of order.

Each mold section, whether it is a posterior mold section or an anterior mold section, includes an optical surface (posterior optical surface on a posterior mold section and anterior optical surface on an anterior mold section) that forms a surface of the ophthalmic lens, as well as a non-optical surface. When injection molding the mold section, the injection molding apparatus typically includes an optical tool assembly for forming the optical surface of the mold section and a non-optical tool assembly for forming the non-optical surface of the mold section. When the ophthalmic lens to be formed includes an asymmetric surface, the mold section optical surface used to form the asymmetric lens surface and the optical tool assembly used to form the mold section optical surface each include corresponding asymmetric surfaces.

Materials

Hydrogels represent one class of materials used for many device applications, including ophthalmic lenses that are made by the molding process. Hydrogels comprise a hydrated, cross-linked polymeric systems containing water in an equilibrium state. Accordingly, hydrogels are copolymers prepared from hydrophilic pre-polymers. In the case of silicone hydrogels, the hydrogel copolymers are generally prepared by polymerizing a mixture containing at least one device-forming silicone-containing pre-polymer and at least one device-forming hydrophilic pre-polymer. Either the silicone-containing pre-polymer or the hydrophilic pre-polymer may function as a crosslinking agent (a crosslinking agent being defined as a pre-polymer having multiple polymerizable functionalities), or alternately, a separate crosslinking agent may be employed in the initial pre-polymer mixture from which the hydrogel copolymer is formed. Silicone hydrogels typically have a water-content ranging from about 10 wt. % to about 80 wt. %.

Examples of useful device-forming hydrophilic pre-polymers include: amides such as N,N-dimethylacrylamide and N,N-dimethylmethacrylamide; cyclic lactams such as N-vinyl-2-pyrrolidone; (meth)acrylated alcohols, such as 2-hydroxyethylmethacrylte and 2-hydroxyethylacrylate; and (meth)acrylated poly(alkene glycols), such as poly(diethylene glycols) of varying chain length containing monomethacrylate or dimethacrylate end caps. Still further examples are the hydrophilic vinyl carbonate or vinyl carbamate pre-polymers disclosed in U.S. Pat. No. 5,070,215, and the hydrophilic oxazolone pre-polymers disclosed in U.S. Pat. No. 4,910,277, the disclosures of which are incorporated herein by reference. Other suitable hydrophilic pre-polymers will be apparent to one skilled in the art.

As mentioned, one preferred class hydrogel ophthalmic lens materials is silicone hydrogels. In this case, the initial lens-forming monomer mixture further comprises a silicone-containing monomer.

Applicable silicone-containing monomeric materials for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Examples of applicable silicon-containing monomers include bulky polysiloxanylalkyl(meth)acrylic monomers. An example of bulky polysiloxanylalkyl(meth)acrylic monomers are represented by the following Formula I:

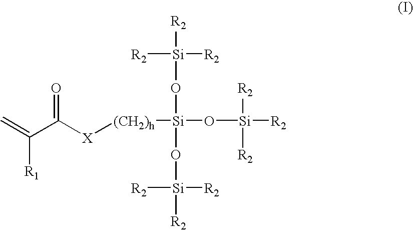

wherein:

X denotes —O— or —NR—;

each R₁ independently denotes hydrogen or methyl;

each R₂ independently denotes a lower alkyl radical, phenyl radical or a group represented by

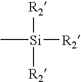

wherein each R′_{2′} independently denotes a lower alkyl or phenyl radical; and h is 1 to 10. One preferred bulky monomer is methacryloxypropyl tris(trimethyl-siloxy)silane or tris(trimethylsiloxy)silylpropyl methacrylate, sometimes referred to as TRIS.

Another class of representative silicon-containing monomers includes silicone-containing vinyl carbonate or vinyl carbamate monomers such as: 1,3-bis[4-vinyloxycarbonyloxy)but-1-yl]tetramethyl-disiloxane; 3-(trimethylsilyl)propyl vinyl carbonate; 3-(vinyloxycarbonylthio)propyl-[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; and trimethylsilylmethyl vinyl carbonate.

An example of silicon-containing vinyl carbonate or vinyl carbamate monomers are represented by Formula II: 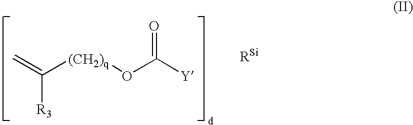
wherein:

Y′ denotes —O—, —S— or —NH—;

R^{Si} denotes a silicone-containing organic radical;

R₃ denotes hydrogen or methyl;

d is 1, 2, 3 or 4; and q is 0 or 1.

Suitable silicone-containing organic radicals R^{Si} include the following:
—(CH₂)_{n′}Si[(CH₂)_{m′}CH₃]₃;
—(CH₂)_{n′}Si[OSi(CH₂)_{m′}CH₃]₃; 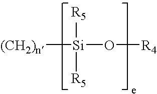 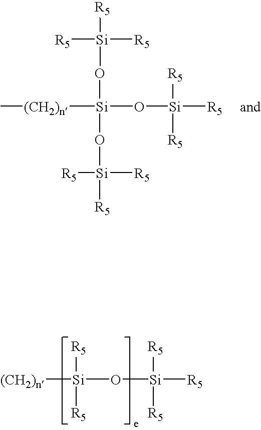
wherein:

R₄ denotes 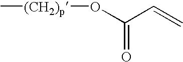
wherein p′ is 1 to 6;

R₅ denotes an alkyl radical or a fluoroalkyl radical having 1 to 6 carbon atoms;

e is 1 to 200; n′ is 1, 2, 3 or 4; and m′ is 0, 1, 2, 3, 4 or 5.

An example of a particular species within Formula II is represented by Formula III:

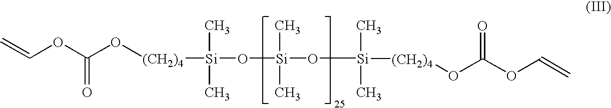

Another class of silicon-containing monomers includes polyurethane-polysiloxane macromonomers (also sometimes referred to as prepolymers), which may have hard-soft-hard blocks like traditional urethane elastomers. Examples of silicone urethane monomers are represented by Formulae IV and V:
E(*D*A*D*G)ₐ*D*A*D*E′; or (IV)
E(*D*G*D*A)ₐ*D*G*D*E′; (V)
wherein:

D denotes an alkyl diradical, an alkyl cycloalkyl diradical, a cycloalkyl diradical, an aryl diradical or an alkylaryl diradical having 6 to 30 carbon atoms;

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

* denotes a urethane or ureido linkage;

a is at least 1;

A denotes a divalent polymeric radical of Formula VI: 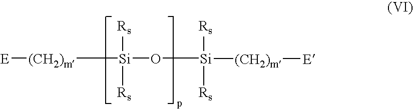
wherein:
each Rₛ independently denotes an alkyl or fluoro-substituted alkyl group having 1 to 10 carbon atoms which may contain ether linkages between carbon atoms;
m′ is at least 1; and
p is a number which provides a moiety weight of 400 to 10,000;
each of E and E′ independently denotes a polymerizable unsaturated organic radical represented by Formula VII: 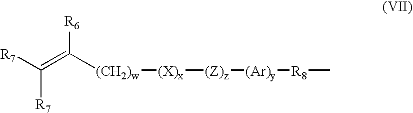
   wherein:

R₆ is hydrogen or methyl;

R₇ is hydrogen, an alkyl radical having 1 to 6 carbon atoms, or a —CO—Y—R₉ radical wherein Y is —O—, —S— or —NH—;

R₈ is a divalent alkylene radical having 1 to 10 carbon atoms;

R₉ is a alkyl radical having 1 to 12 carbon atoms;

X denotes —CO— or —OCO—;

Z denotes —O— or —NH—;

Ar denotes an aromatic radical having 6 to 30 carbon atoms;

w is 0 to 6; x is 0 or 1; y is 0 or 1; and z is 0 or 1.

A more specific example of a silicone-containing urethane monomer is represented by Formula (VIII):

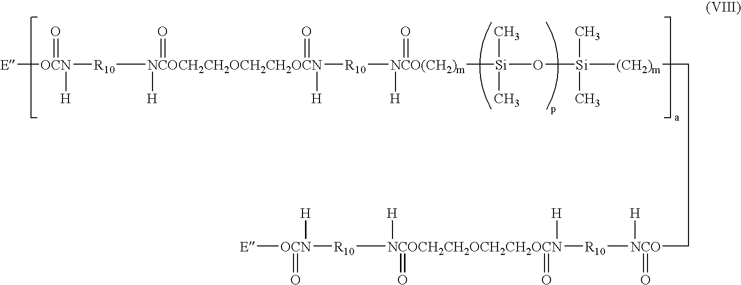

wherein m is at least 1 and is preferably 3 or 4, a is at least 1 and preferably is 1, p is a number which provides a moiety weight of 400 to 10,000 and is preferably at least 30, R₁₀ is a diradical of a diisocyanate after removal of the isocyanate group, such as the diradical of isophorone diisocyanate, and each E″ is a group represented by:

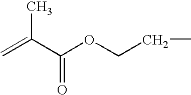

A preferred silicone hydrogel material comprises (based on the initial monomer mixture that is copolymerized to form the hydrogel copolymeric material) 5 to 50 percent, preferably 10 to 25, by weight of one or more silicone macromonomers, 5 to 75 percent, preferably 30 to 60 percent, by weight of one or more polysiloxanylalkyl (meth)acrylic monomers, and 10 to 50 percent, preferably 20 to 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 to Deichert et al. discloses additional unsaturated groups, including acryloxy or methacryloxy. Fumarate-containing materials such as those taught in U.S. Pat. Nos. 5,512,205; 5,449,729; and 5,310,779 to Lai are also useful substrates in accordance with the invention. Preferably, the silane macromonomer is a silicon-containing vinyl carbonate or vinyl carbamate or a polyurethane-polysiloxane having one or more hard-soft-hard blocks and end-capped with a hydrophilic monomer.

Specific examples of ophthalmic lens materials useful in the present invention are taught in U.S. Pat. No. 6,891,010 (Kunzler et al.); U.S. Pat. No. 5,908,906 (Kunzler et al.); U.S. Pat. No. 5,714,557 (Kunzler et al.); U.S. Pat. No. 5,710,302 (Kunzler et al.); U.S. Pat. No. 5,708,094 (Lai et al.); U.S. Pat. No. 5,616,757 (Bambury et al.); U.S. Pat. No. 5,610,252 (Bambury et al.); U.S. Pat. No. 5,512,205 (Lai); U.S. Pat. No. 5,449,729 (Lai); U.S. Pat. No. 5,387,662 (Kunzler et al.); U.S. Pat. No. 5,310,779 (Lai); and U.S. Pat. No. 5,346,976 (Ellis et al.); the disclosures of which are incorporated herein by reference.

In one embodiment, the hydrogel pre-polymer mixture includes a solvent or diluent. Preferably, an organic diluent is included in the initial pre-polymer mixture. As used herein, the term “organic diluent” encompasses organic compounds that are substantially unreactive with the-components in the initial mixture, and are often used to minimize incompatibility of the pre-polymer components in this mixture. Representative organic diluents include: monohydric alcohols, such as C₆-C₁₀ monohydric alcohols; diols such as ethylene glycol; polyols such as glycerin; ethers such as diethylene glycol monoethyl ether; ketones such as methyl ethyl ketone; esters such as methyl heptanoate; and hydrocarbons such as toluene.

Curing

Once the mold unit has been assembled it is subjected to a curing cycle, which polymerizes the pre-polymer inside the mold cavity. Typical ophthalmic lens curing methods involve exposing the pre-polymer mixture to light radiation (such as UV radiation or visible light) and/or thermal energy (e.g. oven curing).

De-Capping

Once curing is complete, one of the mold halves is separated from the ophthalmic lens to reveal the ophthalmic lens formed therein. The mold release process breaks the adhesive bond between the mold sections without damaging the ophthalmic lens, which remains bound to the other mold surface. This process is referred to as decapping. In one embodiment, the decapping occurs when a super-cooled fluid is contacted for a period of time to release the anterior mold half from the ophthalmic lens. In another embodiment, the decapping occurs when a super-cooled fluid is contacted for a period of time to release the anterior mold half from the ophthalmic lens.

In one embodiment, the period of time is a minimum of about 0.1 seconds to a maximum of about 20 seconds. Typically, the period of time effective to clean the molding tool is a minimum of about 0.1 seconds, about 0.5 seconds, about 1.0 seconds, about 2.0 seconds or about 5.0 seconds. Typically, the period of time effective to clean the molding tool is a maximum of about 20 seconds, about 15 seconds, about 10 seconds, about 5 seconds, about 3 seconds, about 2 seconds, or about 1 second.

In another embodiment, the contacting occurs by applying an amount of cryogenic fluid to the one half of the ophthalmic lens mold. Optionally, the contacting occurs by spraying the super-cooled fluid over the ophthalmic lens.

In another embodiment, the dose amount of cryogenic fluid contacted with the mold is a maximum of about 1000 μl, about 800 μl, about 600 μl, about 400 μl, about 200 μl, about 100 μl, about 60 μl, about 40 μl, about 20 μl, about 10 μl, about 8 μl, about 5 μl or about 2 μl. In another embodiment, the dose amount of cryogenic fluid contacted with the mold is a minimum of about 10 μl, about 8 μl, about 5 μl, about 2 μl or about 1 μl. To accomplish low dosing, a nitrogen delivery system such as the SEMIFLEX® system from Vacuum Barrier Corporation, Woburn, Mass. (www.vacuumbarrier.com) is advantageous.

In still another embodiment, the super-cooled fluid is at a temperature below about minus 40° C. Typically, the temperature is below about minus 50° C., about minus 60° C. or about minus 70° C. Typically, the super-cooled fluid is a cryogenic fluid.

In another embodiment, the process is selected from the group consisting essentially of nitrogen, argon, helium, air and carbon dioxide. Preferably, the super-cooled fluid is an inert atmospheric gas. More preferably, the super-cooled fluid is nitrogen.

Solvent Removal

An optional step following de-capping is solvent removal. Unreacted solvent can be removed from the molded ophthalmic lens to further stiffen the ophthalmic lens. Preferably, solvents are volatile thus exposure to air at room temperature for a period of time will remove solvent. Nonetheless, a solvent can be removed in less time by placing the ophthalmic lens in an oven. After the solvent is evaporated from the ophthalmic lens, the ophthalmic lens is removed from the oven for additional processing. The step of solvent removal is preferably performed after the de-capping step and before reservoir removal. Optionally, the step of solvent removal can occur after reservoir removal, but before lens extraction. In another embodiment, the step of solvent removal is avoided by the process of the present invention before the step of releasing the ophthalmic lens. Solvent is optionally extracted or removed from the ophthalmic lens during the step of lens release or during a later step of monomer extraction/lens cleaning where the ophthalmic lens is optionally immersed in or sprayed with a super-cooled fluid.

Reservoir Removal

The manufacturing line may comprise a reservoir removal station to ensure the ophthalmic lens flash or reservoir is removed from the anterior mold section. Optionally, reservoir removal occurs by cutting the reservoir from the ophthalmic lens with a knife blade, which strips the annular lens flash or reservoir from the top of the mold section. Thus, immediately following mold release from the other lens half or second lens half, the reservoir remains bonded to the mold surface and the ophthalmic lens releases from the mold and the reservoir.

Alternatively, the use of a cryogenic fluid can be used to remove the reservoir from the ophthalmic lens during the de capping or lens release step. A temperature differential occurs between the ophthalmic lens flash and/or the mold on the one hand and the ophthalmic lens on the other hand. For example, a cryogenic fluid carefully applied and dosed to ophthalmic lens directly after decapping will create a temperature differential between the ophthalmic lens between the ophthalmic lens and both the mold and the ophthalmic lens flash. The temperature differential will typically separate the ophthalmic lens from both the ophthalmic lens flash and the other mold half or the second mold half.

Lens Release

Next, the ophthalmic lens is released from the other mold or second mold half to which it is attached after the step of decapping. The ophthalmic lens is released when a super-cooled fluid (preferably a cryogenic fluid) is contacted with the ophthalmic lens or the second mold half to release the ophthalmic lens from the second mold half. The super-cooled fluid creates a sudden temperature differential between the ophthalmic lens and the second mold half that will break the bonding between the ophthalmic lens and the second mold half. In one embodiment, the step of pre-polymer extraction, solvent extraction and/or lens cleaning occurs during the step of lens release. In another embodiment, the step of pre-polymer extraction, solvent extraction and/or lens cleaning occurs after the step of lens release.

In one embodiment, the ophthalmic lens release occurs when a super-cooled fluid is contacted for a period of time with either the ophthalmic lens or the anterior mold half to release the anterior mold half from the ophthalmic lens. In another embodiment, the ophthalmic lens release occurs when a super-cooled fluid is contacted with the ophthalmic lens or posterior mold half for a period of time to release the posterior mold half from the ophthalmic lens.

In one embodiment, the period of time is a minimum of about 0.1 seconds to a maximum of about 20 seconds. Typically, the period of time is a minimum of about 0.1 seconds, about 0.5 seconds, about 1.0 seconds, about 2.0 seconds or about 5.0 seconds. Typically, the period of time is a maximum of about 20 seconds, about 15 seconds, about 10 seconds, about 5 seconds, about 3 seconds, about 2 seconds or about 1 second.

In another embodiment, the contacting occurs by applying an amount of cryogenic fluid to the one half of the ophthalmic lens mold. Optionally, the contacting occurs by spraying the super-cooled fluid over the ophthalmic lens.

In another embodiment, the dose amount of cryogenic fluid contacted with the mold is a maximum of about 1000 μl, about 800 μl, about 750 μl, about 600 μl, about 500 μl, about 400 μl, about 200 μl, about 100 μl, about 60 μl, about 40 μl, about 20 μl, about 10 μl, about 8 μl, about 5 μl or about 2 μl. In another embodiment, the dose amount of cryogenic fluid contacted with the mold is a minimum of about 10 μl, about 8 μl, about 5 μl, about 2 μl or about 1 μl. To accomplish low dosing, a nitrogen delivery system such as the SEMIFLEX® system from Vacuum Barrier Corporation, Woburn, Mass. (www.vacuumbarrier.com) is advantageous.

In still another embodiment, the super-cooled fluid is at a temperature below about minus 40° C. Typically, the temperature is below about minus 50° C., about minus 60° C., about minus 70° C. Typically, the super-cooled fluid is a cryogenic fluid.

In another embodiment, the process is selected from the group consisting essentially of nitrogen, argon, helium, air and carbon dioxide. Preferably, the super-cooled fluid is an inert atmospheric gas. More preferably, the super-cooled fluid is nitrogen.

In one embodiment of the present invention, the step of releasing the ophthalmic lens by contacting the ophthalmic lens with a super-cooled fluid, preferably a cryogenic fluid for a period of time sufficient to release the ophthalmic lens is followed by additional dry processing steps. By dry processing steps it is meant processing steps that improve the quality and condition of the ophthalmic lens prior to hydration of the ophthalmic lens. Additional processing steps may include edging/polishing of the ophthalmic lens, solvent removal, monomer extraction (with a solvent other than an aqueous solvent), lens cleaning, inspection, lens coating or other surface treatments, etc.

In another embodiment of the present invention, the step of releasing the ophthalmic lens by contacting the ophthalmic lens with a super-cooled fluid, preferably a cryogenic fluid for a period of time sufficient to release the ophthalmic lens is followed by additional dry processing steps. By dry processing steps it is meant processing steps that improve the quality and condition of the ophthalmic lens prior to hydration of the ophthalmic lens.

Edging/Polishing

In still another embodiment, the ophthalmic lens edge is optionally smoothed and polished. The smoothing of the ophthalmic lens removes lens fragments or portions of the ophthalmic lens reservoir that might adhere to the ophthalmic lens following reservoir removal and/or lens release. The polishing of the ophthalmic lens is generally known in the art and results in an ophthalmic lens that has improved edge surface for comfort. However, after edging and polishing, the ophthalmic lens will have debris in contact with the ophthalmic lens and will require cleaning.

Lens Cleaning/Pre-Polymer Extraction

A cryogenic fluid is used in one embodiment of the present invention to clean the ophthalmic lens of debris and extract pre-polymer and/or solvent. Pre-polymer and or solvent is extracted from a polymer lens by contacting the ophthalmic lens with a super-cooled solvent for a period of time sufficient to extract pre-polymer from the polymer lens.

In one embodiment, the period of time is a minimum of about 0.1 seconds to a maximum of about 20 seconds. Typically, the period of time effective to clean the ophthalmic lens is a minimum of about 0.1 seconds, about 0.5 seconds, about 1.0 seconds, about 2.0 seconds or about 5.0 seconds. Typically, the period of time effective to clean the ophthalmic lens is a maximum of about 20 seconds, about 15 seconds, about 10 seconds, about 5 seconds, about 3 seconds, about 2 seconds or about 1 second.

In another embodiment, the contacting occurs by immersing the ophthalmic lens in a bath containing the super-cooled fluid. Optionally, the contacting occurs by spraying the super-cooled fluid over the ophthalmic lens.

In still another embodiment, the super-cooled fluid is at a temperature below minus 40° C. Typically, the temperature is below about minus 50° C., about minus 60° C. and about minus 70° C. Typically, the super-cooled fluid is a cryogenic fluid.

In another embodiment, the process is selected from the group consisting essentially of nitrogen, argon, helium, air and carbon dioxide. Preferably, the super-cooled fluid is an inert atmospheric gas. More preferably, the super-cooled fluid is nitrogen.

Typically, the extraction of pre-polymers occurs after the ophthalmic lens is removed from a mold that forms the ophthalmic lens. Optionally, the extraction of pre-polymers occurs while the ophthalmic lens is being released from a mold that forms the ophthalmic lens.

Washing and Hydration

After the inspection stage, the ophthalmic lenses proceed to a washing and/or hydration stage depending upon the type of lens. Typically, the ophthalmic lenses are supported on a carrier that supports a plurality of lenses in separate compartments e.g. 16, 32 etc. Optionally, the final packaging is used as the carrier during the washing and hydration step. In either instance, each lens is washed with purified water or in the case of hydrogel lenses hydrated with purified water until it has expanded to its full dimensions. Alternatively, the ophthalmic lens is washed or hydrated with a buffered saline solution in one or more washing steps. Water (or buffered saline solution) is extracted from the polymer matrix of the ophthalmic lens. Fresh water added to rinse the ophthalmic lenses. The ophthalmic lenses may be subjected to several rinses by extraction and addition of purified water. Preferably, a check is made to ensure the presence of an ophthalmic lens in a compartment after each extraction of water. It is believed that the previous step of pre-polymer extraction with a super-cooled fluid will reduce the number of stages of rinses with water or buffered saline solution.

Inspection

Optionally, the ophthalmic lenses are inspected to identify lenses with optical defects. The inspection can be manual or automatic. If an ophthalmic lens fails the inspection test, it is deposited in a reject bin. If the ophthalmic lens passes the inspection test, the ophthalmic lens can be conveyed to the next processing step. The inspection step occurs prior to packaging. Typically, inspection occurs immediately prior to packaging. Alternatively or additionally, the inspection step occurs before the contact lens is hydrated. In one embodiment, an inspection step occurs after the ophthalmic lens is released from the mold and before the contact lens is further processed.

Packaging

Transferred from the carrier into containers or blisters for final packaging the identity of the ophthalmic lenses is monitored via the carrier indicator. For example, the carrier identifier may be scanned as the carrier enters a processing station which will trigger the computer to provide the necessary information for printing a label or information directly on the lid stock which is applied to feel the blisters or containers. In general, applying a lid stock which is heat-sealed to the perimeter of the blister or container seals the blisters or containers.

Suitable lid stock comprises a laminate of metal foil on a polypropylene film. The lid stock may be printed e.g. by laser etching before or after its application to the container or blister. Alternatively, a label may be printed and applied to the lid stock before or after its application. The information printed on the lid stock or label may provide information for use by the end user or may be a machine readable identifier e.g. bar code, matrix code etc. to be used in later packaging operations. The labeling will provide sufficient information such that the ophthalmic lens in each blister or container may be identified in terms of its prescription and SKU, if necessary by interrogating the computer database. Thus, product integrity is ensured from inspection of the individual lens to its packaging in the blister or container.

Prior to application of the lid stock each blister or container is checked for the presence of an ophthalmic lens. After application of the lid stock the container or blister is examined for leaks and bad seals.

Thereafter, the packaged lenses are subjected to sterilization. The blisters or containers may be transferred to a tray or carrier for passage through the sterilization stage. The carrier is provided with a carrier indicator which is read and the information recorded in the computer memory so that the identity of the ophthalmic lenses and SKU is associated with the carrier indicator information.

After sterilization the ophthalmic lenses may be stored in a warehouse and cartoned and labeled in response to a specific order. Alternatively, the ophthalmic lenses may be cartoned and labeled to fulfill an order or for stockpiling ready for future orders.

What is claimed is:

1. A process for separating a hydrogel contact lens from at least one mold half selected from the group comprising the anterior half and the posterior half of a contact lens, the process comprising the step of contacting either the contact lens or the one half with a maximum of about 1000 μl of a super-cooled fluid to create a temperature differential between the contact lens and the one half.

2. The process of claim 1, wherein less than about 750 μl of super-cooled fluid is contacted with either the one half or the contact lens.

3. The process of claim 1, wherein less than about 600 μl of super-cooled fluid is contacted with either the one half or the contact lens.

4. The process of claim 1, wherein less than about 500 μl of super-cooled fluid is contacted with either the one half or the contact lens.

5. The process of claim 1, wherein the hydrogel contact lens is formed of a silicone containing pre-polymer.

6. The process of claim 1, wherein the hydrogel contact lens is formed of a hydrophilic pre-polymer.

7. The process of claim 1, wherein the period of time is a minimum of about 0.1 seconds to a maximum of about 20 seconds.

8. The process of claim 1, wherein the contacting occurs by spraying the super-cooled fluid.

9. The process of claim 1, wherein the super-cooled fluid is at a temperature below about minus 40° C.

10. The process of claim 1, wherein the super-cooled fluid is selected from the group consisting essentially of nitrogen, argon, helium, air and carbon dioxide.
